(19) United States
(12) Patent Application Publication
(10) Pub. No.: US 2026/0080216 A1
(43) Pub. Date: Mar. 19, 2026

(54) BUILDING CUSTOM TEXT EMBEDDINGS MODELS FOR GEOSCIENCE AND ENERGY DOMAIN

(71) Applicant: Schlumberger Technology Corporation, Sugar Land, TX (US)

(72) Inventors: Sai Shravani Sistla, Menlo Park, CA (US); Monisha Manoharan, Menlo Park, CA (US)

(21) Appl. No.: 19/328,484

(22) Filed: Sep. 15, 2025

Related U.S. Application Data
(60) Provisional application No. 63/694,760, filed on Sep. 13, 2024.

(51) Int. Cl. G06N 3/0455; G06N 3/08

(52) U.S. Cl. CPC G06N 3/0455; G06N 3/08

(57) ABSTRACT

Disclosed are methods and systems for: receiving raw geoscience or energy domain data associated with a resource site, such that the raw geoscience or energy domain data comprises a plurality of textual data and image data having a plurality of disparate file/document formats; receiving a user input associated with the raw geoscience or energy domain data; applying the raw geoscience and energy domain data and the user input to a configured embeddings model thereby generating one or more of: a text embedding associated with the raw geoscience or energy domain data, and an image embedding associated with the raw geoscience or energy domain data; implementing, based on the applying, one or more of: a semantic search computing operation and a classification or clustering computing operation associated with a multidimensional vector space; and generating a report, based at least on the semantic search/classification/clustering computing operation.

### CROSS-REFERENCE TO RELATED APPLICATIONS

This application claims priority to, and benefit of U.S. Provisional Patent App. No. 63/694,760, filed on Sep. 13, 2024, and titled “Building Custom Text Embeddings Models For Geoscience And Energy Domain,” which is incorporated herein by reference in its entirety for all purposes.

### INTRODUCTION

The disclosed method is directed to configuring embeddings models for geoscience and energy domain applications.

### BACKGROUND

Text embeddings models have served as foundational blocks for the success and adoption of modern machine learning, natural language processing and artificial intelligence applications. With the recent advent of generative artificial intelligence (AI) and Large Language Models (LLMs), most industries are experiencing a quick shift in AI adoption. However, there is a gap between general purpose AI models and LLMs relative to specialized applications in specific domains.

There is therefore a need for domain adaptations of AI models and/or LLMs to bridge the aforementioned gap.

### SUMMARY

This disclosure is directed to methods, systems, and computer program products for converting raw geoscience data or energy domain data into a multi-dimensional vector space for predictive modeling in energy development. According to an embodiment, a method for converting raw geoscience data or energy domain data into a multi-dimensional vector space for predictive modeling in energy development comprises: determining an embeddings computing model associated with geoscience data or energy domain data; receiving first raw geoscience or energy domain data associated with a first resource site, such that the first raw geoscience or energy domain data comprises a first plurality of textual data and image data having a first plurality of disparate file formats or document formats; pairing data samples comprised in the first plurality of textual data and image data having the first plurality of file formats, thereby generating one or more of first paired data samples; activating one or more of: a text encoder comprised in the embeddings computing model, the text encoder comprising a transformer-based computing architecture, an image encoder comprised in the embeddings computing model, the image encoder comprising one of a computer vision transformer or a convolutional neural network; training, based on the one or more of the paired data samples, the embeddings computing model to determine similarity data between: a first text embedding that is generated based on applying a first paired text-image sample comprised in the one or more of the paired data samples to the text encoder, and a first image embedding that is generated based on applying the first paired text-image sample comprised in the one or more of the paired data samples to the image encoder; implementing, one of: aggregating together, based on the similarity data, the first text embedding and the first image embedding in a multi-dimensional vector space, and separating from each other, based on the similarity data, the first text embedding from the first image embedding in the multi-dimensional vector space; configuring, based on the aggregating or separating, the embeddings computing model thereby generating a configured embeddings model; receiving second raw geoscience or energy domain data associated with the first resource site or a second resource site, such that the second raw geoscience or energy domain data comprises a second plurality of textual data and image data having a second plurality of disparate file formats or document formats; receiving a user input associated with the second raw geoscience or energy domain data; applying the second raw geoscience and energy domain data and the user input to the configured embeddings model thereby generating one or more of: a second text embedding associated with the second raw geoscience or energy domain data, and a second image embedding associated with the second raw geoscience or energy domain data; implementing, based on the applying, one or more of: a semantic search computing operation to determine a matching between the first text embedding or the first image embedding and the second text embedding or the second image embedding respectively, a classification or clustering computing operation that classifies the second text embedding or second image embedding into data categories comprised in the multi-dimensional vector space; and generating a report, based at least on the semantic search computing operation or the classification or clustering computing operation.

In other embodiments, a system and a computer program can include or execute the method described above. These and other implementations may each optionally include one or more of the following features.

The embeddings computing model, according to some embodiments, is parameterized by: the text encoder, the text encoder being configured to convert text data derived from one or more disparate file formats that contain the first raw geoscience or energy domain data into a first transformed data; the image encoder, the image encoder being configured to convert image data derived from one or more disparate file formats that contain the first raw geoscience or energy domain data into a second transformed data; and a projection parameter or transformer configured to transform or map the first transformed data and the second transformed data into the multi-dimensional vector space.

Furthermore, workflows 500a and 500b may further comprise applying a loss function to the configured computing model to improve a response or predictive accuracy of the configured computing model.

In some cases, the loss function referenced above is based on a cosine similarity computing operation, the cosine similarity computing operation comprising a computing operation that measures a similarity or dissimilarity between: a first vector in the multi-dimensional vector space representing the first text embedding or the first image embedding; and a benchmark vector associated with the multi-dimensional vector space and which represents ground truth data associated with the first resource site, such that the similarity or dissimilarity is based on a cosine of an angle between the first vector and the benchmark vector.

According to some embodiments, the first raw geoscience or energy domain data comprises: seismic data captured at the first resource site or the second resource site; well log data associated with the first resource site or the second resource site; geochemical data associated with the first resource site or the second resource site; and remote sensing data associated with the first resource site or the second resource site.

In some instances, the similarity data is generated based on a contrastive computing process that determines whether the first text embedding has a link or a connection to the first image embedding.

It is appreciated that the link or connection indicates that/whether the first text embedding is associated with a subsurface structure characterized by the first image embedding.

It is appreciated that the multi-dimensional vector space comprises: the first plurality of textual data and image data as a first set of datapoints in a vector space; and the second plurality of textual data and image data as a second set of datapoints in the vector space.

It is further appreciated that the vector space is configured for organizing and processing raw or unstructured geoscience data or energy domain data.

Furthermore, the first set of datapoints comprise a first numerical vector while the second set of datapoints comprise a second numerical vector.

In some cases, configuring the embeddings computing model comprises one of: applying, a contrastive learning computing operation to train the embeddings computing model to determine whether the first text embedding and the first image embedding comprise a positive pair, the positive pair indicating a data relationship or a data linkage between the first text embedding and the first image embedding; and/or applying, the contrastive learning computing operation to train the embeddings computing model to determine whether the first text embedding and the first image embedding comprise a negative pair, the negative pair indicating an absence of the data relationship or a data linkage between the first text embedding and the first image embedding.

According to one embodiment, the data relationship or data linkage between the first text embedding and the first image embedding indicate a text description and its matching image associated with sensor measurements capturing surface or subsurface data associated with the first resource site or the second resource site.

Moreover, the user input comprises a digital question or a computing request to determine energy development information associated with the second raw geoscience or energy domain data based on the configured embeddings computing model.

According to one embodiment, the report comprises one or more of: subsurface data indicating subsurface data relationships between rocks, minerals, and geological processes associated with the first resource site or the second resource site based on the user input; responses or retrieved documents associated with the subsurface data relationships based on the user input; multimodal data integration that combines effects of the subsurface data indicating the relationships between the rocks, minerals, and geological processes associated with the first resource site or the second resource site; predictive modeling data indicating one or more of: a first recommendation strategy for energy exploration associated with the first resource site or the second resource site, a second recommendation strategy for extracting energy from the first resource site or the second resource site, an energy production forecast associated with the first resource site or the second resource site, and an energy transportation strategy associated with the first resource site or the second resource site.

In some implementations, the report comprises a visualization comprising textual or image data indicating the subsurface data, the responses or retrieved documents, and the predictive modeling data.

Additionally, the first raw geoscience or energy domain data comprising the first plurality of textual data and image data having the first plurality of disparate file formats or document formats is converted into a unified file or document format comprising a markdown data format prior to the pairing.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 depicts a high-level workflow for the disclosed methods.

FIG. 2 depicts a cross-sectional view of a resource site for which the process of FIGS. 4, 5A-5B may be executed.

FIG. 3 depicts a networked system illustrating a communicative coupling of devices or systems associated with the resource site of FIG. 2.

FIG. 4 depicts an exemplary detailed workflow for the disclosed methods.

FIGS. 5A-5B show exemplary workflows 500a and 500b for converting raw geoscience data or energy domain data into a multi-dimensional vector space for predictive modeling in energy development.

### DETAILED DESCRIPTION

Reference will now be made in detail to embodiments, examples of which are illustrated in the accompanying drawings and figures. In the following detailed description, numerous specific details are set forth in order to provide a thorough understanding of the disclosed subject-matter. However, it will be apparent to one of ordinary skill in the art that the solutions disclosed may be practiced without these specific details. In other instances, well-known methods, procedures, components, circuits, and networks have not been described in detail so as not to unnecessarily obscure aspects of the embodiments.

The disclosed systems and methods may be accomplished using interconnected devices and systems that obtain a plurality of data associated with various parameters of interest at a resource site. The workflows/flowcharts described in this disclosure, according to some embodiments, implicate a new processing approach (e.g., hardware, special purpose processors, and specially programmed general-purpose processors) because such analyses are too complex and cannot be done by a person in the time available or at all. Thus, the described systems and methods are directed to tangible implementations or solutions to specific technological problems in developing natural resources such as oil, gas, water well industries, and other mineral exploration operations. More specifically, the systems and methods presently disclosed may be applicable to operations associated with stratigraphic analysis associated with a resource site.

Attention is now directed to methods, techniques, infrastructure, and workflows for operations that may be carried out at a resource site. Some operations in the processing procedures, methods, techniques, and workflows disclosed herein may be combined while the order of some operations may be changed. Some embodiments include an iterative refinement of one or more data models associated with the resource site via feedback loops executed by one or more computing device processors and/or through other control devices/mechanisms that make determinations regarding whether a given action, template, or resource data, etc., is sufficiently accurate.

### Overview

This disclosure addresses the need for domain customizations of AI models and/or LLMs to: build domain-specific foundational LLMs from scratch; and/or finetune general purpose LLMs to generate domain-specific LLMs; and/or build custom text embeddings models (also called embeddings computing model elsewhere herein) that can power applications by, for example, implementing an LLM-based Retrieval-Augmented Generation (RAG) system; and/or classify tasks in the energy domain; and/or implement a similarity search system in the energy domain; and/or fine-tune new energy development models; etc.

According to some embodiments, this disclosure provides methods and systems that build custom text embeddings models in the geoscience and energy domain. According to one embodiment, different computing processes including dataset generation, dataset training, and results evaluation are provided herein. In particular, this disclosure provides an end-to-end pipeline for building domain-specific text embeddings models that can be used across a variety of down-stream applications such as text-classification computing operations, semantic similarity computing operations, information-retrieval computing operations, and retrieval in LLM-based RAG systems.

According to one embodiment, evaluation of the disclosed custom text embeddings models can include creating benchmark datasets for various tasks in the geoscience and the energy domain. Furthermore, the following exemplary computing operations may be implemented using the disclosed methods and systems:
Generating datasets: Raw data from different document formats such as Portable Document Format (PDF), Extensible Markup Language (XML) format, and Hypertext Markup Language (HTML), etc., can be converted into a form suitable for training text embeddings models. According to one embodiment, the disclosed method includes converting or processing documents in a first file format (e.g., PDF, XML format, and HTML format) to a second file format which can be a markdown file format. The markdown file format of the converted documents can be split at various levels (e.g., header levels). In some embodiments, suitable question-answer pairs (e.g., appropriate instructions, questions, or answer pairs) associated with data records can be generated using competent LLMs for the levels. Additionally, various techniques can be implemented at this stage to generate appropriate datasets and/or synthetic datasets. This can reduce manual dataset creation and increases dataset volume and diversity thereby improving the overall quality of the training data.
Model selection and fine-tuning: According to one embodiment, a computing ledgerboard comprising a multi-task and a multi-language comparison framework of embeddings within models may be leveraged for one or more of the disclosed processes. In particular, the leaderboard can be associated, or otherwise based on multiple scores that indicate performance data associated with the disclosed embeddings models. For fine-tuning of the embeddings models, it may be necessary to pick the right embeddings that suit a downstream task and/or application under consideration. A loss function may be chosen based on the format of a given dataset under consideration for the downstream task. Model fine-tuning using the generated datasets can enhance the disclosed model's ability to generate more domain-aware and context aware text embeddings.
Evaluation of fine-tuned models on downstream tasks: The evaluation of fine-tuned embeddings models can be divided into two sub-components.
   Creation of a benchmark test dataset: According to one embodiment, there are no specific text-based energy domain datasets that can evaluate the performance of embeddings models on various downstream tasks. Hence, a Retrieval-Augmented Generation (RAG) system may be used for training dataset retrieval in a downstream task. This training dataset may comprise question-answer pairs that are suitable for downstream tasks. Selected as a subcategory of the training dataset is a constructed vector index associated with the training dataset. For example, the test dataset can be queried against the vector index to compute or generate various performance metrics. This beneficially provides a systematic approach to evaluating the disclosed embeddings models (e.g., text-based embeddings models) in terms of their performance, accuracy, and reliability.
   Appropriate metric selection and calculation: According to one embodiment, the choice of metrics for evaluating a the disclosed embeddings models depends on a curated test dataset. In particular, the metrics can either be absolute metrics such as hit rate metrics, mean reciprocal rank (MRR) metrics, etc. In some embodiments, an LLM evaluator, also called a judge LLM, may be used to assess one or more of the disclosed embeddings models. In addition, this disclosure provides methods and systems that generate metrics that ensure developing robust benchmarks and provide a comprehensive performance assessment of the disclosed embeddings models.
      These aspects are further discussed below.

### High-Level Workflow

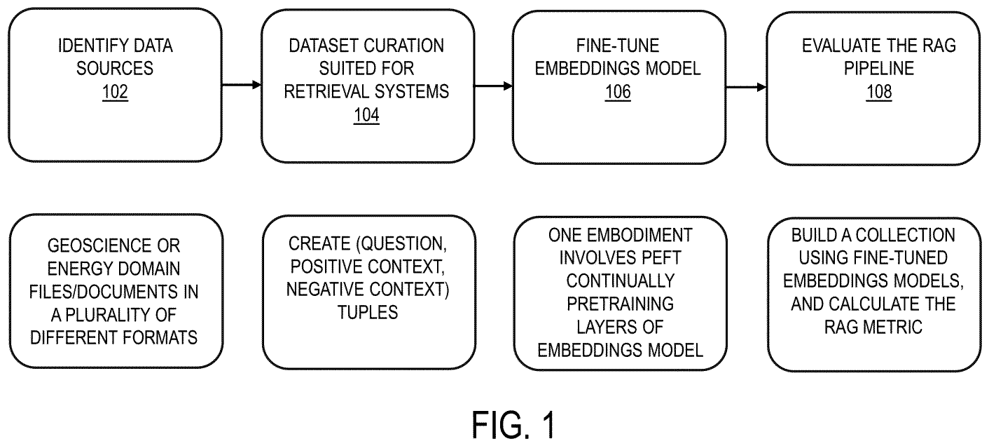

FIG. 1 shows an exemplary high-level workflow 100 for generating metrics associated with the disclosed methods and systems. It is appreciated that a data engine stored in a memory device may cause a computer processor to execute the various processing stages of the workflow 100 of FIG. 1. The various stages of the workflow 100 may be executed in a different order from that shown in the workflow 100. In some cases, one or more of the stages illustrated may be optional.

At block 102, the data engine may identify data sources. In one embodiment, the data sources comprise geoscience data sources. In another embodiment, the data sources comprise energy domain data sources. In some cases, the data sources comprises a domain associated with energy exploration, energy refinement, energy transportation, and/or energy distribution.

At block 104, the data engine generates, based on data from the data sources, one or more tuples, each of the one or more tuples comprising: question data, positive context data, and negative context data. In some embodiments, the data from the data sources comprises geoscience data and/or energy domain data that can be used to generate the tuples. Furthermore, the data engine converts the data from the data sources from a first data format to a second data format.

At block 106, the data engine configures, based on the one or more tuples, the embeddings model, thereby generating a trained embeddings model. In some embodiments, configuring the embeddings model is based on training one or more data layers of the embeddings model. Furthermore, training the one or more data layers can comprise or be based on parameter-efficient fine tuning (PEFT).

At block 108, the data engine evaluates the trained embeddings model. According to one embodiment, evaluating the trained embeddings model comprises generating one or more performance metrics. Furthermore, the one or more performance metrics can comprise retrieval augmentation generation (RAG) metrics. These aspects are further discussed below.

### Resource Site

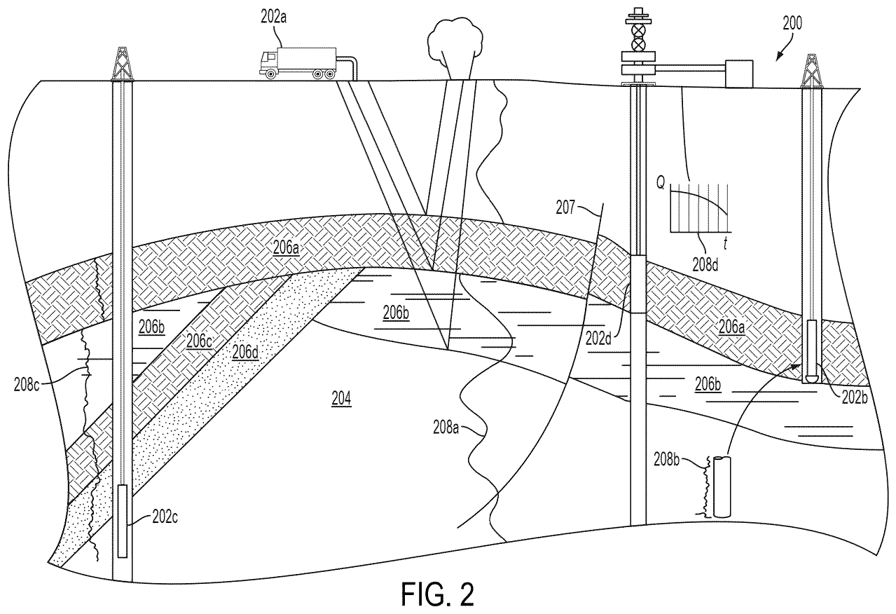

FIG. 2 shows a cross-sectional view of a resource site 200 for which the process of FIG. 1 may be executed. While the illustrated resource site 200 represents a subterranean formation, the resource site 200, according to some embodiments, may be below water bodies such as oceans, seas, lakes, ponds, wetlands, rivers, or other marine environments.

According to one embodiment, various measurement tools capable of sensing one or more resource site data such as seismic two-way travel time, density, resistivity, production rate, etc., of a subterranean formation and/or geological formations may be provided at the resource site. As an example, wireline tools may be used to obtain measurement information related to geological attributes (e.g., geological attributes of a wellbore and/or reservoir) including geophysical and/or chemical information. For example, the chemical information may include chemical information associated with the subsurface and/or chemical information associated with the surface/above ground areas of the resource site 200.

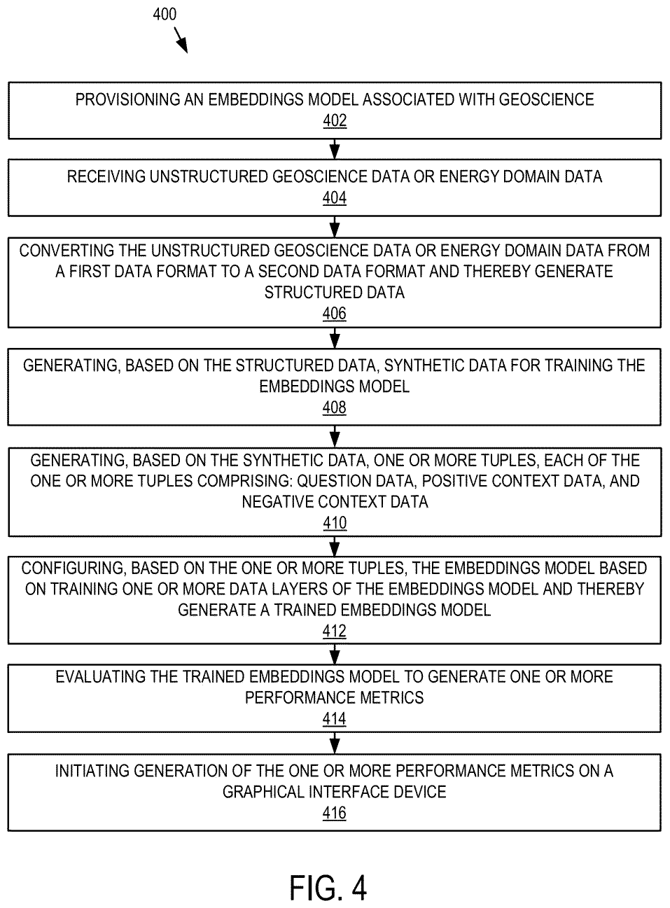

In some embodiments, various sensors may be located at various locations around the resource site 200 to monitor and collect data and/or core samples (e.g., samples of subsurface materials) for executing the process of FIG. 4.

Part, or all, of the resource site 200 may be on land, on water, or below water. In addition, while a resource site 200 is depicted, the technology described herein may be used with any combination of one or more resource sites (e.g., multiple oil fields or multiple wellsites, one or more saline aquifers, one or more depleted oil/gas fields, etc.), one or more processing facilities, etc.

As can be seen in FIG. 2, the resource site 200 may have data acquisition tools 202a, 202b, 202c, and 202d positioned at various locations within the resource site 200. The subterranean structure 204 may have a plurality of geological formations 206a-206d. As shown, this structure may have several formations or layers, including a shale layer 206a, a carbonate layer 206b, a shale layer 206c, and a sand layer 206d. A fault 207 may extend through the shale layer 206a and the carbonate layer 206b. The data acquisition tools, for example, may be adapted to take measurements and detect geophysical and/or chemical characteristics of the various formations shown.

While a specific subterranean formation with specific geological structures is depicted, it is appreciated that the resource site 200 may contain a variety of geological structures and/or formations, sometimes having extreme complexity. In some locations of a given geological structure, for example below a water line (e.g., aquifer) relative to the given geological structure, fluid may occupy pore spaces of the formations. Each of the measurement devices may be used to measure properties of the formations and/or other geological features. While each data acquisition tool is shown as being in specific locations in FIG. 2, it is appreciated that one or more types of measurements may be taken at one or more locations across one or more sources of the resource site 200 or other locations for comparison and/or analysis.

The data collected from various sources at the resource site 200 may be processed and/or evaluated and/or used as training data, and/or used to generate high resolution result sets for characterizing a resource at the resource site, and/or used for generating resource models, etc. In one embodiment, the core sample data and/or data collected by a set of sensors at the resource site may include data associated with the number of wells of a first reservoir or second reservoir at the resource site, data associated with the number of grid cells of the first or second reservoir, data associated with the average permeability of the first or second reservoir, data associated with the production duration history (e.g., number of years of production) of the first reservoir or second, etc.

Data acquisition tool 202a is illustrated as a measurement truck, which may comprise devices or sensors that take measurements of the subsurface through sound vibrations such as, but not limited to, seismic measurements. Drilling tool 202b may include a downhole sensor adapted to perform logging while drilling (LWD) data collection. The wireline tool 202c may include a downhole sensor deployed in a wellbore or borehole. Production tool 202d may be deployed from a production unit or Christmas tree into a completed wellbore. Examples of resource site data that may be measured include weight on bit data, torque on bit data, subterranean pressure (e.g., underground fluid pressure) data, temperature data, flow rate data, soil/rock/fluid composition data, rotary speed data, particle count data, voltage data, current data, and/or other parameters of operations as further discussed below.

In one embodiment, sensors may be positioned about the resource site 200 to collect data (e.g., raw data) relating to various oil field operations, such as sensors deployed by the data acquisition tools 202. The sensors may include any type of sensor such as a metrology sensor (e.g., temperature sensor, humidity sensor, pressure sensor, etc.), an automation enabling sensor, an operational sensor (e.g., pressure sensor, H₂S sensor, thermometer, depth sensor, tension sensor), evaluation sensors, etc., that can be used for acquiring data regarding a geological formation at the resource site 200, wellbore information, formation fluid/gas information, wellbore fluid information, and data associated with gas/oil/water comprised in the formation/wellbore fluid. For example, the sensors may include accelerometers, flow rate sensors, pressure transducers, electromagnetic sensors, acoustic sensors, temperature sensors, chemical agent detection sensors, nuclear sensor, and/or any additional suitable sensors.

In one embodiment, the data captured by the one or sensors may be used to characterize, or otherwise generate one or more parameter values for a high-resolution result set used to, for example, label or configure a machine learning (ML) engine or a resource model associated with the case may require. In other embodiments, test data or synthetic data may also be used in developing the ML engine or resource model (e.g., a subsurface model) via one or more parameterization/labeling operations such as those discussed in association with FIG. 4.

Evaluation sensors may be featured in downhole tools such as tools 202b-202d and may include, for instance, electromagnetic sensors, acoustic sensors, nuclear sensors, and optical sensors. Examples of tools including evaluation sensors that can be used in the framework of the current method include electromagnetic tools including imaging sensors such as FMI™ or QuantaGeo™ (mark of SLB, Houston, TX); induction sensors such as Rt Scanner™ (mark of SLB, Houston, TX), multifrequency dielectric dispersion sensor such as Dielectric Scanner™ (mark of SLB, Houston, TX); acoustic tools including sonic sensors, such as Sonic Scanner™ (mark of SLB, Houston, TX) or ultrasonic sensors, such as pulse-echo sensor as in UBI™ or PowerEcho™ (marks of SLB, Houston, TX) or flexural sensors PowerFlex™ (mark of SLB, Houston, TX); nuclear sensors such as Litho Scanner™ (mark of SLB, Houston, TX) or nuclear magnetic resonance sensors; fluid sampling tools including fluid analysis sensors such as InSitu Fluid Analyzer™ (mark of SLB, Houston, TX); distributed sensors including fiber optic. Such evaluation sensors may be used in particular for evaluating the formation in which the well is formed (e.g., determining petrophysical or geological properties of the formation), for verifying the integrity of the well (e.g., such as generating casing or cement properties of a given well to assess its integrity) and/or analyzing produced fluid (flow rate data, type of fluid data, etc.) produced or extracted from a given well.

As shown, data acquisition tools 202a-202d may generate data plots or measurements 208a-208d, respectively. These data plots may be depicted within the resource site 200 to demonstrate data generated by some of the operations executed at the resource site 200.

Data plots 208a-208c are examples of static data plots that may be generated by data acquisition tools 202a-202c, respectively. However, it is herein contemplated that data plots 208a-208c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data associated with the plots may be incorporated into site planning, modeling a test at the resource site 200, etc. The respective measurements that can be determined may be any of the above.

Other data may also be collected, include: historical data of the resource site 200 and/or sites similar to the resource site 200; user input data; information (e.g., economic information) associated with the resource site 200 and/or sites similar to the resource site 200; and/or other measurement data and other parameters of interest. Similar measurements may also be used to measure changes in formation features associated with the resource site 200 over a period of time.

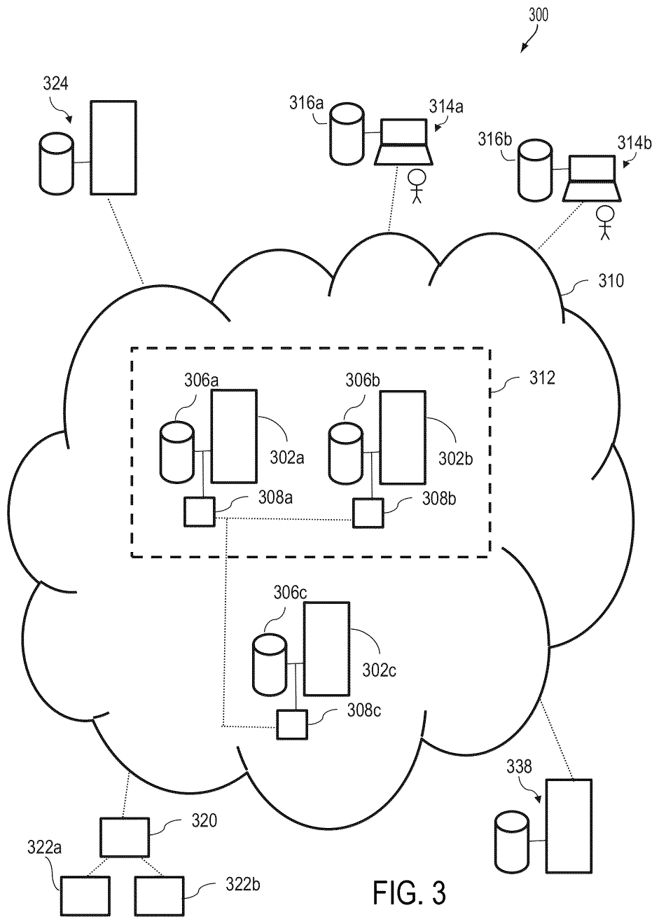

Computer facilities such as those discussed in association with FIG. 3 may be positioned at various locations about the resource site 200 (e.g., a surface unit) and/or at remote locations. A surface unit (e.g., one or more terminals 320) may be used to communicate with the onsite tools and/or offsite computing systems, as well as with other surface or downhole sensors. The surface unit may be capable of sending commands to the resource site equipment/systems, and receiving data therefrom. The surface unit may also collect data generated during production operations (e.g., fluid production operations) and can produce output data, which may be stored or transmitted for further processing.

The data collected by sensors associated with the resource site 200 may be used alone or in combination with other data. For example, data collected the sensors associated with the resource site 200 may be stored in one or more databases and/or transmitted to onsite computing systems associated with the resource site 200 or offsite computing systems that are dependent or independent of the resource site 200. According to one embodiment, data captured using the sensors associated with the resource site 200 may be categorized into historical data, real-time data, or combinations thereof. The real time data, for example, may be used in real-time, near real-time, or stored for later use. The captured sensor data may also be combined with historical sensor data or other inputs for further analysis or for modeling purposes to optimize energy development (e.g., fluid production processes) at the resource site 200. In one embodiment, sensor data from the resource site 200 is stored in separate databases, or combined for storage in a single database.

### Network System

FIG. 3 shows a high-level network system diagram 300 illustrating a communicative coupling of devices or systems associated with the resource site 200 described in FIG. 2. The system shown in this figure may include a set of processors 302a, 302b, and 302c for executing one or more processes discussed herein. The set of processors 302 may be electrically coupled to one or more servers (e.g., computing systems) including memory 306a, 306b, and 306c that may store for example, program data, databases, and other forms of data. Each server of the one or more servers may also include one or more communication devices 308a, 308b, and 308c. The set of servers may provide a cloud-computing platform 310. In one embodiment, the set of servers includes different computing devices that are situated in different locations and may be scalable based on the needs and workflows associated with the resource site 200. The communication devices of each server may enable the servers to communicate with each other through a local or global network such as an Internet network. In some embodiments, the servers may be arranged as a town 312, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud networks, which may also communicate over public communication links. Note that cloud-computing platform 310 may include a private network and/or portions of public networks. In some cases, a cloud-computing platform 310 may include remote storage and/or other application processing capabilities.

The system of FIG. 3 may also include one or more user terminals 314a and 314b each including at least a processor to execute programs, a memory (e.g., 316a and 316b) for storing data, a communication device and one or more user interfaces and devices that enable the user to receive, view, and transmit information. In one embodiment, the user terminals 314a and 314b is a computing system having interfaces and devices including keyboards, touchscreens, display screens, speakers, microphones, a mouse, styluses, etc. The user terminals 314 may be communicatively coupled to the one or more servers of the cloud-computing platform 310. The user terminals 314 may be client terminals or expert terminals, enabling collaboration between clients and experts through the system of FIG. 3.

The system of FIG. 3 may also include at least one or more resource sites 200 having, for example, a set of terminals 320, each including at least a processor, a memory, and a communication device for communicating with other devices communicatively coupled to the cloud-computing platform 310. The resource site 200 may also have a set of sensors (e.g., one or more sensors described in association with FIG. 2) or sensor interfaces 322a and 322b communicatively coupled to the set of terminals 320 and/or directly coupled to the cloud-computing platform 310. In some embodiments, data collected by the set of sensors/sensor interfaces 322a and 322b may be processed to generate a one or more resource models (e.g., reservoir models) or one or more resolved datasets used to generate the resource model which may be displayed on a user interface associated with the set of terminals 320, and/or displayed on user interfaces associated with the set of servers of the cloud computing platform 310, and/or displayed on user interfaces of the user terminals 314. Furthermore, various equipment/devices discussed in association with the resource site 200 may also be communicatively coupled to the set of terminals 320 and or communicatively coupled directly to the cloud-computing platform 310. The equipment and sensors may also include one or more communication device(s) that may communicate with the set of terminals 320 to receive computing commands/instructions locally and/or remotely from the resource site 200 and also send data/equipment statuses/updates to other terminals such as the user terminals 314.

The system of FIG. 3 may also include one or more client servers 324 including a processor, memory, and communication device. For communication purposes, the client servers 324 may be communicatively coupled to the cloud-computing platform 310, and/or to the user terminals 314a and 314b, and/or to the set of terminals 320 at the resource site 200 and/or to sensors at the resource site 200, and/or to other non-sensor equipment at the resource site 200.

A processor, as discussed with reference to the system of FIG. 3, may include a microprocessor, a graphical processing unit (GPU), a microcontroller, a processor module or subsystem, a programmable integrated circuit, a programmable gate array, or other control systems or computing device.

The memory/storage media discussed above in association with FIG. 3 can be implemented as one or more computer-readable or machine-readable storage media that are non-transitory. In some embodiments, the storage media referenced herein may be distributed within and/or across multiple internal and/or external enclosures of a computing system and/or additional computing systems. In addition, the storage media referenced herein may include one or more different forms of computing memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. In one embodiment, a “non-transitory” computer readable medium refers to the medium itself (i.e., tangible, not a signal) and not data storage persistency (e.g., RAM vs. ROM).

Note that instructions can be provided on one or more computer-readable medium or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). The storage medium or media can be located either in a computer system running the machine-readable instructions, or located at a remote site from which machine-readable instructions can be downloaded over a network for execution.

It is appreciated that the described system of FIG. 3 is an example that may have more or fewer components than shown, may combine additional components, and/or may have a different configuration or arrangement of the components. The various components shown may be implemented in hardware, software, or a combination of both hardware, and software, including one or more data processing and/or application specific integrated circuits.

Further, the steps in FIG. 4 described below may be implemented by running one or more functional modules in an information processing apparatus such as general-purpose processors or application specific chips, such as ASICs, FPGAs, PLDs, GPUs or other appropriate devices associated with the system of FIG. 3. For example, the flowchart of FIG. 4 below may be executed using a data engine or a data processing module (e.g., computing module) stored in memory 306a, 306b, or 306c such that the data engine/data processing module includes instructions that are executed by the one or more processors such as processors 302a, 302b, or 302c as the case may be. The various modules of FIG. 3, combinations of these modules, and/or their combination with general hardware are included within the scope of protection of the disclosure. While one or more computing processors (e.g., processors 302a, 302b, or 302c) may be described as executing steps associated with, for example, FIG. 4, the one or more computing device processors may be associated with the cloud-based computing platform 310 and may be located at one location or distributed across multiple locations. In one embodiment, the one or more computing device processors may also be associated with other systems of FIG. 3 other than the cloud-computing platform 310.

According to one embodiment, the network system diagram 300 includes an intelligence server 338 configured to control or regulate, in conjunction with, or independently of the data engine associated with the systems coupled to the cloud computing platform 310 for training of one or more of the disclosed computing models such as the embeddings computing model. In some cases, the intelligence model server 338 can train a given intelligence model using at least one of: zero-shot learning, few-shot learning, and fine-tuning. Additionally or alternatively, one or more of the disclosed models may comprise, or be based on, or associated with at least one of: GPT-4, LLaMA-3, BLOOM, PaLM, GPT-3.5, BERT, Gemini, LaMDA, Perplexity, or Falcon. Additionally or alternatively, one or more of the disclosed computing models (e.g., embeddings computing model) may also include multiple intelligence models (e.g., separately trained intelligence models) and therefore may be configured to perform and/or execute multiple processes in parallel. The intelligence models disclosed (e.g., embeddings models) herein may include various artificial intelligence systems or structures, including but not limited to large language models (LLMs), deep learning models, machine learning models, neural networks (e.g., convolutional neural networks (CNNs), recurrent neural networks (RNNs), transformers), expert systems, decision trees, and reinforcement learning models.

Additionally or alternatively, one or more of the disclosed models (e.g., embeddings model) may also include multiple intelligence models (e.g., separately trained intelligence models) and therefore may be configured to perform and/or execute multiple processes in parallel. In some embodiments, the intelligence model server 338 may include a special chipset for processing large amounts data and/or complex computing operations in a reduced amount of time. These chipsets may include, but are not limited to, Graphics Processing Units (GPUs), Tensor Processing Units (TPUs), Field-Programmable Gate Arrays (FPGAs), Application-Specific Integrated Circuits (ASICs) specifically designed for artificial intelligence (AI) workloads, or neuromorphic chips. Such chipsets can be configured to have parallel computing architectures, enabling efficient execution of matrix multiplications and convolutions, which comprise computing operations in a given intelligence model, particularly deep learning models. This parallel processing capability can allow for rapid ingestion, analysis, and processing of vast datasets (e.g., raw geoscience and/or energy domain datasets), thereby accelerating model training, inference, and overall performance of the intelligence model server 338. The chipsets referenced herein may further incorporate dedicated memory architectures (e.g., High Bandwidth Memory (HBM)) optimized for the data throughput requirements of large intelligence models.

In some embodiments, the disclosed intelligence models (e.g., embeddings model), or components thereof, may be implemented and/or deployed on dedicated hardware accelerators embedded within a system-on-chip (SoC) or as discrete integrated circuits. These hardware implementations can facilitate high-speed data processing and low-latency inference, needed for real-time applications. Furthermore, the intelligence model server 338, or components thereof, including the specialized chipsets and intelligence models, may be provided by a third-party vendor or service provider (e.g., via cloud-based AI/ML platforms) or may be developed and maintained in-house.

In some instances, the intelligence model server 338, or components thereof, including the specialized chipsets and intelligence models, may be directly integrated into the cloud computing platform 310. This direct integration allows for optimized communication pathways, potentially reducing latency and enhancing data privacy by keeping sensitive data within the cloud computing platform 310.

According to one embodiment, the disclosed embeddings computing model can comprise various intelligent structures that can be used for predictive modeling associated with a resource site. In addition, the disclosed embeddings computing model can comprise, for example, one or more artificial neural networks, deep learning networks, or other machine learning processes, which are trained on extensive datasets encompassing surface or subsurface data associated with a resource site. In one embodiment, the intelligent structures of the embeddings computing model can be configured, after training, to analyze complex, non-linear relationships within datasets or training data, identifying patterns indicative of the surface or subsurface analysis data required for energy development operations such as: subsurface data indicating relationships between rocks, minerals, and geological processes associated with the first resource site or the second resource site based on the user input; responses or retrieved documents associated with the subsurface data relationships based on the user input; multimodal data integration that combines effects of the subsurface data indicating the relationships between the rocks, minerals, and geological processes associated with the first resource site or the second resource site; predictive modeling data indicating one or more of: a first recommendation strategy for energy exploration associated with the first resource site or the second resource site, a second recommendation strategy for extracting energy from the first resource site or the second resource site, an energy production forecast associated with the first resource site or the second resource site, and an energy transportation strategy associated with the first resource site or the second resource site.

In some cases, the intelligent structures within, for example, an embeddings computing model can process input data (e.g., user inputs such as inquiries about a resource site or request for documents associated with the resource site). Through iterative learning and refinement, an embeddings computing model can continuously adjust its internal parameters to enhance the accuracy of its outputs.

In some embodiments, a computing system is provided that includes at least one processor, at least one memory, and one or more programs stored in the at least one memory, such that the programs comprise instructions, which when executed by the at least one processor, are configured to perform any method disclosed herein.

In some embodiments, a computer readable storage medium is provided, which has stored therein one or more programs, the one or more programs including instructions, which when executed by a processor, cause the processor to perform any method disclosed herein.

In some embodiments, a computing system is provided that includes at least one processor, at least one memory, and one or more programs stored in the at least one memory for performing any method disclosed herein. In some embodiments, an information processing apparatus for use in a computing system is provided for performing any method disclosed herein.

### Embodiments

### Dataset Generation

Geoscience and/or energy domain data are critical for understanding the surface and/or subsurface structures with or without energy resources natural resources. These data can be collected using various techniques, from ground-based surveys to satellite imagery, to help characterize geological formations, locate resources, and/or monitor environmental conditions. In some instances, data associated with geoscience and/or energy domains comprise seismic data that provide a detailed image or computing model of subsurface or subterranean structures using sound waves. For example, the seismic data may include 2-dimensional (2D) or 3-dimensional (3D) images or computing models of the subsurface or subterranean structures, showing geological layers of the subsurface. The data attributes or data components associated with generating the seismic data include travel time data of seismic waves propagated into the subsurface, amplitude data associated with said seismic waves, and frequency data associated with said seismic waves. These data attributes can be acquired using one or more sensors discussed in association with the resource site. In some cases, the sensors comprise acquisition systems such as: vibroseis trucks communicating with geophones; air guns towed behind a vessel to release compressed air that creates a seismic pulse that can be detected hydrophones, etc.

In some implementations, the geoscience and/or energy domain data comprises well log data that provides direct measurement of subsurface properties at specific locations of the resource site. For example, the well log data can comprise measurements taken down a borehole and can include geophysical log data (e.g., gamma ray data, resistivity data, density data, etc.), which reveal rock type properties, porosity properties, and fluid content properties associated with a given subsurface. Other data types comprised in the well log data include drilling log data (e.g., rate of subsurface penetration data, mud data etc.) and core sample analysis data associated with an extracted core (e.g., extracted soil or rock material) from the subsurface. Exemplary systems for capturing the well log data include logging tools with sensors that are lowered into the wellbore on a wireline. These tools can measure various physical properties of the surrounding rock and fluids associated with the wellbore. This can be achieved using, for example, sensors on a drilling rig itself which form part of a Measurement While Drilling (MWD) system or a Logging While Drilling (LWD) system to acquire data in real-time as a given well is being drilled at a resource site.

In some cases, the geoscience and/or energy domain data comprises geochemical data that beneficially helps in determining the composition and origin of rocks and fluids in a subsurface associated with a resource site. This data can include hydrocarbon gas analysis data derived from soil samples, which can indicate potential fluid reservoirs (e.g., oil and gas reservoirs), and isotopic analysis data of rock and fluid samples associated with the resource site to understand their history and source. According to one embodiment, the geochemical data may be acquired using through surface surveys, where soil or water samples are collected for laboratory analysis. In a well associated with the resource site, for example, downhole fluid sampling tools can capture reservoir fluids for detailed geochemical testing at a lab.

In exemplary implementations, the geoscience and/or energy domain data comprises remote sensing data that is captured, for example, using satellites and aircraft, to provide a broad view of the Earth's surface and near-surface environments. This data can include satellite imagery data and/or aerial photography data that provide visual and spectral information used for mapping geological features. Other remote sensing data include Light Detection and Ranging (LIDAR) data, which creates high-resolution digital elevation computing models, and hyperspectral imagery information which can identify specific minerals based on their specific spectral signatures. According to one embodiment, satellites in orbit can capture the disclosed remote sensing data. Furthermore, aircraft or drones equipped with sensors like LIDAR, magnetometers, and gamma-ray spectrometers can be used for airborne remote sensing surveys to generate the remote sensing data. In some implementations, this approach can cover large areas more efficiently than ground-based methods.

Additionally, the energy domain data can also include a variety of operational and production data (e.g., fluid production associated with energy development. This data can comprise fluid production volume data (e.g., fluid production volume data associated with oil, gas, and water from wells), wellhead pressure data, fluid flow rate data, and operational downtime log data. These data can be useful in monitoring production systems to improve performance and/or optimizing energy production. Exemplary acquisition systems for capturing energy domain data include Supervisory Control and Data Acquisition (SCADA) systems and smart meters that can collect real-time data from a network of sensors and devices at well sites, pipelines, and power plants. This information can be used for real-time monitoring and advanced analytics associated with energy development.

According to one embodiment, a data engine may be used to receive geoscience and/or energy domain data such as those discussed above. The received geoscience and/or energy domain data may comprise raw that is in an unstructured or nonuniform data format. In some cases, the unstructured or nonuniform format comprises one or more of portable document format (PDF), Extensible Markup Language format, or a Hyper Text Markup Language (HTML) format, etc.

According to one embodiment, an Azure form recognizer system may be leveraged to facilitate transforming the raw data from a first data format to a more structured or uniform data format. In particular, this tool can be used to accurately extract text and structure from a variety of unstructured document formats such as PDF, XML format, and HTML format.

According to one embodiment, the raw data can be passed through the Azure form recognizer system to extract text and appropriated data structure, which are then converted into structured data format. For example, the structured data format comprises a markdown format. This markdown format can comprise a lightweight and easy-to-read data format that is particularly suited for the disclosed LLMs due to its simplicity and structure. Furthermore, the markdown format can support a variety of elements such as headings data, lists data, links data, and code blocks data, providing flexibility in representing different types of content data associated with the geoscience and energy domains.

According to one embodiment, the converted markdown format or markdown documents are stored in an Azure Blob storage system. This storage system can be scalable, secure, and integrates seamlessly with other Azure services, making it a service of choice for managing large volumes of the disclosed geoscience or energy domain data.

As used herein, a text embeddings model comprises a machine learning model that converts raw textual and/or image data and/or video data associated with raw geoscience and/or energy domain data (e.g., raw data referenced elsewhere herein) into a numerical format that is digestible by a computing system. These numerical representations can be referred to as data vectors or text embeddings. In particular, the core idea is to transform the geoscience and/or energy domain data into a list of numbers, where each number represents data interpretations or data meaning associated with the geoscience and/or energy domain data.

According to one embodiment, a training dataset for the disclosed text embeddings models can have different data formats including a plain text data format, a PDF, an XML format, an HTML format, a Comma-Separated Values (CSV) format, a Tab-Separated Values (TSV) format, etc. For example, the plain text data format can comprise text data such that each line of the text data represents a single text document or a text unit (e.g., sentence, paragraph, or even a whole article). This can be suitable for a computing model's learning or training based on text representations.

According to one embodiment, text unit pairs such as sentence pairs can be generated for the aforementioned text data format based on the training dataset. For example, tasks involving data relationships between texts (e.g., similarity, paraphrasing, etc.), can use sentence pairs, where each sentence line contains two sentences separated by a delimiter like a tab or a comma. Furthermore, the sentence pairs can also have a label or a score representing whether a sentence pair is a positive pair with a similar score (e.g., highly similar score) or a negative pair with a dissimilar score (e.g., highly dissimilar score). It is appreciated that a triplet data configuration or data system comprising an anchor pair, the positive pair, and the negative pair are herein contemplated.

For retrieval-based tasks, each line of the dataset can contain one or more of an anchor pair, context data, answer data, and/or label or score data), where an answer to a given query to the embeddings model can or cannot be found in a given context depending on the label for said context. Furthermore, tasks requiring specific semantic understanding including sentiment analysis and topic classification can require labeling data. For example, each line of the dataset can contain text and its corresponding label. For example, the sentence “This geographic location has subsurface resources!” can have a “positive” data label.

According to some embodiments, extracted data elements in the markdown format (e.g., markdowns) can be used to generate datasets in a format suitable for retrieval of an anchor pair, context data, answers, label data or score data. For example, an anchor pair can be thought of as a question; the context data may represent text associated with the question and which needs to be answered; the answers can indicate responses to the question; while the label or score data indicates an association of the context relative to the question. According to one embodiment, the label data can be positive if the question can be answered based on the context data, and negative if the question cannot be answered from the context. In some cases, the score data represents how relevant the question and/or context are relative to each other. It is appreciated that the score data comprises an optional field.

In some embodiments, extracted markdowns at a header level can be split at a header level to build one or more suitable data chunks. In addition, each of the one or more data chunks can be passed as context to a competent application programming interface (API)-based LLMs such as Generative Pre-trained Transformer 4 (GPT-4) and Gemini-pro-flash to generate a plurality of questions or questions data (e.g., at least five questions) and answers or answers data from each of said one or more data chunks. According to one embodiment, different types of instructions may be given to the disclosed embeddings models thereby prompting the embeddings models to create a diverse set of questions data and answers data. For a given question, the answers generated from the embeddings model with their attendant context can be marked as positive. Another answer for a different question may be randomly selected from an answer pool and assigned as a negative answer.

The same experiment may be repeated for negative contexts too. In some cases, thousands (e.g., at least 74000) of pairs of questions, positive context data, and negative context data from a plurality of documents from geoscience- and/or energy-related datasets.

In some cases, the disclosed dataset generation process can beneficially enable an end-to-end workflow designed to prepare raw, unstructured documents for advanced processing and model training. This component enables converting diverse document formats into a standardized and structured file format (e.g., markdown file formats or simply markdowns) that is more accessible and interpretable by Language Learning Models (LLMs).

### Model Selection and Fine-Tuning

According to one embodiment, a text unit transformer model is used in implementing the disclosed methods and systems. This text unit transformer model can comprise a sentence transformer (e.g., SBERT) computing module for accessing, using, and training the disclosed text and image embeddings models. In particular, SBERT can be used to compute metrics for the disclosed embeddings models using SBERT models that can calculate similarity scores based on cross-encoder models. In some cases, a wide selection of a plurality of pre-trained transformer models (e.g., over 5000 pre-trained models) can be used in the generation of the disclosed embeddings models.

### Decoder-Based Architectures

According to one embodiment, large language models (e.g., LLM2Vec) may be leveraged in generating the disclosed embeddings models. In particular, LLM2Vec beneficially provide an unsupervised approach that can transform a decoder-only LLM into a text encoder as well.

### Loss Function

According to one embodiment, a loss function may be used to quantify the difference between the predicted outputs of the disclosed embeddings models relative to actual target values or ground truth values. The choice of the loss function can depend on the dataset under consideration as well as the target task of the disclosed embeddings models.

According to one embodiment, multiple negative ranking loss functions may be used in assessing the disclosed embeddings models. This loss function can also be used to fine-tuning embeddings models. For a batch of data points, a cosine score or a similarity score can be computed between an anchor sentence with each of the positive and negative data samples across data batches associated with the disclosed embeddings models. A similarity matrix may be generated based on the batch of data such that diagonal elements of the similarity matrix may have the highest absolute scores indicating similarity scores for the batch of data points.

### Fine-Tuning Sentence Transformers

According to one embodiment, training datasets for the disclosed embeddings models can be generated using, for example, a Llama framework or a GPT-4 (e.g., GPT-4 Omni or simply, GPT-4o) transformer system to create questions, answers, and context data triplet pairs based on the raw documents or raw data referenced above. In particular, the following process can be used to generate the training dataset of the disclosed embeddings model:
extract text from PDF files, XML files, and HTML files associated with, or derived from geoscience and/or energy domains and store said text in a markdown file format;
generate question-answer-context tuples based on the extracted text using a model transformer such as GPT-4o;
   the higher the number of tuples, the higher would be the variety of tuples for configuring the disclosed embeddings models;
   chunk sizes associated with markdowns can be fine-tuned for the embeddings models based on a given context length (e.g., about 8000 in size);
   in some cases, approximately 23000 tuples or 50000 tuples can be generated, respectively in 12 hours and 20 hours;
   the question-answer-context tuples can be generated using the Llama-index framework.

### EXAMPLES

According to one embodiment, two approaches can be used to finetune multiple (e.g., two or more) different embeddings models. The first embeddings model may be initialized and fine-tuned on a mixture of multilingual datasets. In this example, no negative data samples are generated and/or fine-tuned for this model. Temporally, this first model's original parameters can be finetuned by its data layers. For example, a first data layer and three other layers of the first embeddings model may be finetuned based on a time window spanning multiple epochs.

In the case of the second embeddings model, both positive and negative data samples can be generated from energy data and/or geoscience data as described in the above section. In addition, this model can be finetuned using, for example, a temporal window comprising approximately 25 hours for 3 epochs.

According to one embodiment, the second embeddings model can be used or customized to generate three finetuned models including: a first model that is finetuned using energy data and geoscience data; a second model that is finetuned using just the geoscience data; and a third model that is finetuned using just the energy data.

### Evaluation of Finetuned Model(s) on Downstream Tasks

Evaluation of finetuned models can be divided into multiple categories:
Creation of benchmark test dataset: In this instance, the test dataset may be selected in a Retrieval-Augmented Generation (RAG) system as a downstream task. This test data may simply have a question-answer pair for this downstream task.
For the energy data, a subfolder of markdowns can be selected as test dataset. Following this, the markdowns may be split into data chunks. In addition, the finetuned model can be used to generate embeddings of the data chunks. These embeddings can be used to construct a vector index. At this stage, a set of question-answer-context triplets can be constructed from this test dataset using, for example, a GPT-4o and validated shortly thereafter. The embeddings can also be computed for the questions associated with the question-answer-context triplets. Next, the vector index may be queried using the embeddings of the questions from the question-answer-context triplets. The result, according to one embodiment, comprises the retrieved context chunks. Furthermore, a similarity function of the vector index can be used to retrieve the most semantically relevant data chunks that might hold the answers relative to questions at issue. The retrieved context and/or data chunks can then be compared against the ground truth context from which the questions are generated using a set of metrics. This provides a systematic approach to evaluating text-based embeddings models in terms of their performance, accuracy, and reliability.
Appropriate metric selection and calculation: In this second instant, the choice of metrics depends on a curated test dataset. The selected metrics can either be absolute such as hit rate, mean reciprocal rank (MRR), etc., or a metric based on an advanced evaluation framework such as RAGAS with a judge LLM performing the model assessment. According to one embodiment, choosing the right metrics ensures developing robust benchmarks that provide a comprehensive performance assessment of the disclosed embeddings models. If the chunk containing the actual answer is retrieved by the vector index when queried over the question, then the success rate of the embeddings model is designated a data value of 1. Otherwise, the data designation is 0. Furthermore, the MRR metric can be used to evaluate the quality of information retrieval systems and recommendations associated with the disclosed embeddings models. In particular, the disclosed MMR metric can a measure how well a system retrieves relevant documents or file formats and can be useful when a system returns a ranked list of results. The MRR metric can be calculated by averaging the reciprocal rank of each query. The reciprocal rank can comprise the multiplicative inverse of the rank of a first relevant document associated with the disclosed embeddings models. For example, if a relevant document is retrieved at rank 1, the reciprocal rank is 1, and if it is retrieved at rank 2, the reciprocal rank is 0.5. Using an advanced evaluation framework such as RAGAS with an LLM judge can be used to evaluate the performance of the disclosed embeddings model. In particular, the judge model can assess the quality, accuracy, and relevance of the outputs generated by a candidate embeddings model. By employing the RAGAS framework, a more detailed and context-aware evaluation of the embeddings model's performance can be determined. This approach leverages the LLM's associated with the disclosed embeddings models understanding of language and context to provide a more comprehensive assessment of the embeddings models.

FIG. 4 shows an exemplary detailed workflow 400 for configuring an embeddings model. It is appreciated that a data engine stored in a memory device may cause a computer processor to execute the various processing stages of workflow 400. The various processing stages of workflow 400 may be executed in a different order from those shown in the workflow 400. Some stages may be optional.

At block 402, the data engine may provision an embeddings model associated with geoscience.

At block 404, the data engine receives unstructured geoscience data or energy domain data.

At block 406, the data engine converts the unstructured geoscience data or energy domain data from a first data format to a second data format and thereby generate structured data

At block 408, the data engine generates, based on the structured data, synthetic data for training the embeddings model.

At block 410, the data engine generates, based on the synthetic data, one or more tuples, each of the one or more tuples comprising: question data, positive context data, and negative context data.

At block 412, the data engine configures, based on the one or more tuples, the embeddings model based on training one or more data layers of the embeddings model and thereby generate a trained embeddings model.

At block 414, the data engine evaluates the trained embeddings model to generate one or more performance metrics.

At block 416, the data engine initiates generation of the one or more performance metrics on a graphical interface device.

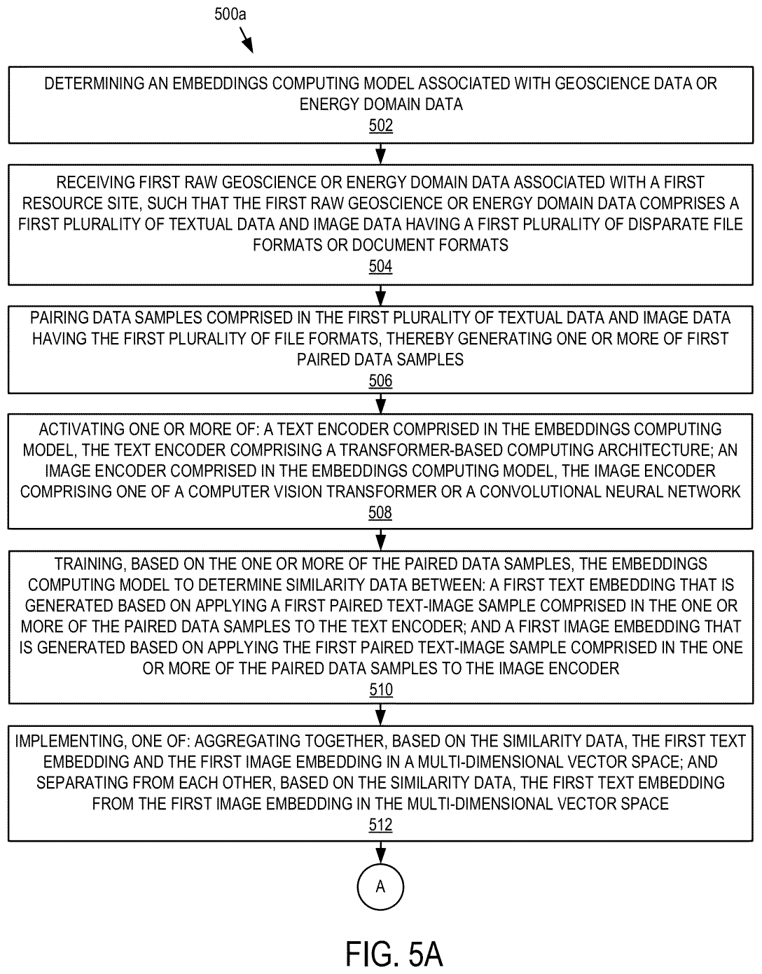

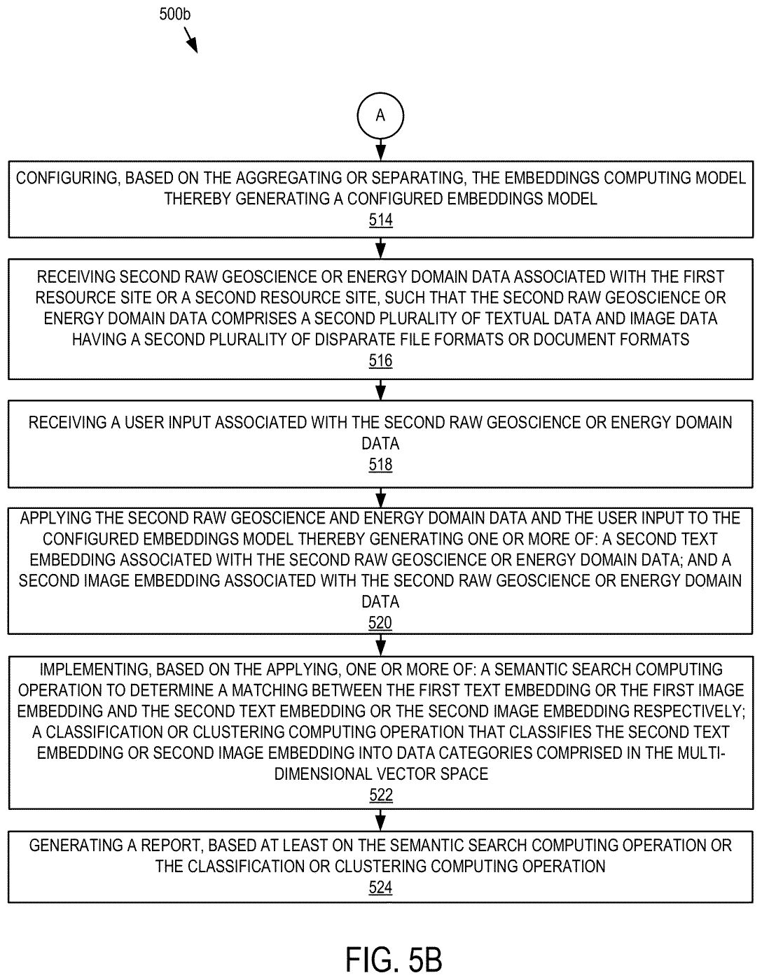

FIGS. 5A-5B show exemplary workflows 500a and 500b for converting raw geoscience data or energy domain data into a multi-dimensional vector space for predictive modeling in energy development. It is appreciated that a data engine stored in a memory device may cause a computer processor to execute one or more processing stages of workflows 500a and 500b. For example, the disclosed techniques may be implemented as a data engine of a computing platform associated with a geological software tool such that the data engine enables optimally implementing predictive modeling in the geoscience or energy domain.

At block 502, the data engine may determine an embeddings computing model associated with geoscience data or energy domain data.

At block 504, the data engine may receive first raw geoscience or energy domain data associated with a first resource site, such that the first raw geoscience or energy domain data comprises a first plurality of textual data and image data having a first plurality of disparate file formats or document formats.

At block 506, the data engine may pair data samples comprised in the first plurality of textual data and image data having the first plurality of file formats, thereby generating one or more of first paired data samples.

Turning to block 508, the data engine may activate one or more of: a text encoder comprised in the embeddings computing model, the text encoder comprising a transformer-based computing architecture; and an image encoder comprised in the embeddings computing model, the image encoder comprising one of a computer vision transformer or a convolutional neural network.

At block 510, the data engine may train, based on the one or more of the paired data samples, the embeddings computing model to determine similarity data between: a first text embedding that is generated based on applying a first paired text-image sample comprised in the one or more of the paired data samples to the text encoder; and a first image embedding that is generated based on applying the first paired text-image sample comprised in the one or more of the paired data samples to the image encoder.

At block 512, the data engine may implement, one of: aggregating together, based on the similarity data, the first text embedding and the first image embedding in a multi-dimensional vector space; and separating from each other, based on the similarity data, the first text embedding from the first image embedding in the multi-dimensional vector space.

Turning to block 514, the data engine configures, based on the aggregating or separating, the embeddings computing model thereby generating a configured embeddings model.

At block 516, the data engine receives second raw geoscience or energy domain data associated with the first resource site or a second resource site, such that the second raw geoscience or energy domain data comprises a second plurality of textual data and image data having a second plurality of disparate file formats or document formats.

At block 518, the data engine receives a user input associated with the second raw geoscience or energy domain data.

At block 520, the data engine may apply the second raw geoscience and energy domain data and the user input to the configured embeddings model thereby generating one or more of: a second text embedding associated with the second raw geoscience or energy domain data; and a second image embedding associated with the second raw geoscience or energy domain data.

At block 522, the data engine may implement, based on the applying, one or more of: a semantic search computing operation to determine a matching between the first text embedding or the first image embedding and the second text embedding or the second image embedding respectively; and a classification or clustering computing operation that classifies the second text embedding or second image embedding into data categories comprised in the multi-dimensional vector space.

Additionally, the data engine may generate a report, at block 524, based at least on the semantic search computing operation or the classification or clustering computing operation.

These and other implementations may each optionally include one or more of the following features.

The embeddings computing model, according to some embodiments, is parameterized by: the text encoder, the text encoder being configured to convert text data derived from one or more disparate file formats that contain the first raw geoscience or energy domain data into a first transformed data; the image encoder, the image encoder being configured to convert image data derived from one or more disparate file formats that contain the first raw geoscience or energy domain data into a second transformed data; and a projection parameter or transformer configured to transform or map the first transformed data and the second transformed data into the multi-dimensional vector space.

Furthermore, workflows 500a and 500b may further comprise applying a loss function to the configured computing model to improve a response or predictive accuracy of the configured computing model.

In some cases, the loss function referenced above is based on a cosine similarity computing operation, the cosine similarity computing operation comprising a computing operation that measures a similarity or dissimilarity between: a first vector in the multi-dimensional vector space representing the first text embedding or the first image embedding; and a benchmark vector associated with the multi-dimensional vector space and which represents ground truth data associated with the first resource site, such that the similarity or dissimilarity is based on a cosine of an angle between the first vector and the benchmark vector.

According to some embodiments, the first raw geoscience or energy domain data comprises: seismic data captured at the first resource site or the second resource site; well log data associated with the first resource site or the second resource site; geochemical data associated with the first resource site or the second resource site; and remote sensing data associated with the first resource site or the second resource site.

In some instances, the similarity data is generated based on a contrastive computing process that determines whether the first text embedding has a link or a connection to the first image embedding.

It is appreciated that the link or connection indicates that/whether the first text embedding is associated with a subsurface structure characterized by the first image embedding.

It is appreciated that the multi-dimensional vector space comprises: the first plurality of textual data and image data as a first set of datapoints in a vector space; and the second plurality of textual data and image data as a second set of datapoints in the vector space.

It is further appreciated that the vector space is configured for organizing and processing raw or unstructured geoscience data or energy domain data.

Furthermore, the first set of datapoints comprise a first numerical vector while the second set of datapoints comprise a second numerical vector.

In some cases, configuring the embeddings computing model comprises one of: applying, a contrastive learning computing operation to train the embeddings computing model to determine whether the first text embedding and the first image embedding comprise a positive pair, the positive pair indicating a data relationship or a data linkage between the first text embedding and the first image embedding; and/or applying, the contrastive learning computing operation to train the embeddings computing model to determine whether the first text embedding and the first image embedding comprise a negative pair, the negative pair indicating an absence of the data relationship or a data linkage between the first text embedding and the first image embedding.

According to one embodiment, the data relationship or data linkage between the first text embedding and the first image embedding indicate a text description and its matching image associated with sensor measurements capturing surface or subsurface data associated with the first resource site or the second resource site.

Moreover, the user input comprises a digital question or a computing request to determine energy development information associated with the second raw geoscience or energy domain data based on the configured embeddings computing model.

According to one embodiment, the report comprises one or more of: subsurface data indicating subsurface data relationships between rocks, minerals, and geological processes associated with the first resource site or the second resource site based on the user input; responses or retrieved documents associated with the subsurface data relationships based on the user input; multimodal data integration that combines effects of the subsurface data indicating the relationships between the rocks, minerals, and geological processes associated with the first resource site or the second resource site; predictive modeling data indicating one or more of: a first recommendation strategy for energy exploration associated with the first resource site or the second resource site, a second recommendation strategy for extracting energy from the first resource site or the second resource site, an energy production forecast associated with the first resource site or the second resource site, and an energy transportation strategy associated with the first resource site or the second resource site.

In some implementations, the report comprises a visualization comprising textual or image data indicating the subsurface data, the responses or retrieved documents, and the predictive modeling data.

Additionally, the first raw geoscience or energy domain data comprising the first plurality of textual data and image data having the first plurality of disparate file formats or document formats is converted into a unified file or document format comprising a markdown data format prior to the pairing.

While any discussion of or citation to related art in this disclosure may or may not include some prior art references, such discussions are neither concessions nor acquiescence to the position that any given reference is prior art or analogous prior art.

The foregoing description, for purpose of explanation, has been described with reference to specific embodiments. However, the illustrative discussions above are not intended to be exhaustive or to limited to the precise forms disclosed. Many modifications and variations are possible in view of the above teachings. The embodiments were chosen and described in order to explain the principles and its practical applications, to thereby enable others skilled in the art to use various embodiments with various modifications as are suited to the particular use contemplated.

It is appreciated that the term optimize/optimal and its variants (e.g., efficient or optimally) may simply indicate improving, rather than the ultimate form of ‘perfection’ or the like.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope. The first object or step, and the second object or step, are both objects or steps, respectively, but they are not to be considered the same object or step.

The terminology used in the description herein is for the purpose of describing particular embodiments and is not intended to be limiting. As used in the description and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

1. A method for converting raw geoscience data or energy domain data into a multi-dimensional vector space for predictive modeling in energy development, the method comprising:
determining an embeddings computing model associated with geoscience data or energy domain data;
receiving first raw geoscience or energy domain data associated with a first resource site, such that the first raw geoscience or energy domain data comprises a first plurality of textual data and image data having a first plurality of disparate file formats or document formats;
pairing data samples comprised in the first plurality of textual data and image data having the first plurality of file formats, thereby generating one or more of first paired data samples;
activating one or more of:
a text encoder comprised in the embeddings computing model, the text encoder comprising a transformer-based computing architecture,
an image encoder comprised in the embeddings computing model, the image encoder comprising one of a computer vision transformer or a convolutional neural network;
training, based on the one or more of the paired data samples, the embeddings computing model to determine similarity data between:
a first text embedding that is generated based on applying a first paired text-image sample comprised in the one or more of the paired data samples to the text encoder, and
a first image embedding that is generated based on applying the first paired text-image sample comprised in the one or more of the paired data samples to the image encoder;
implementing, one of:
aggregating together, based on the similarity data, the first text embedding and the first image embedding in a multi-dimensional vector space, and
separating from each other, based on the similarity data, the first text embedding from the first image embedding in the multi-dimensional vector space;
configuring, based on the aggregating or separating, the embeddings computing model thereby generating a configured embeddings model;
receiving second raw geoscience or energy domain data associated with the first resource site or a second resource site, such that the second raw geoscience or energy domain data comprises a second plurality of textual data and image data having a second plurality of disparate file formats or document formats;
receiving a user input associated with the second raw geoscience or energy domain data;
applying the second raw geoscience and energy domain data and the user input to the configured embeddings model thereby generating one or more of:
a second text embedding associated with the second raw geoscience or energy domain data, and
a second image embedding associated with the second raw geoscience or energy domain data;
implementing, based on the applying, one or more of:
a semantic search computing operation to determine a matching between the first text embedding or the first image embedding and the second text embedding or the second image embedding respectively,
a classification or clustering computing operation that classifies the second text embedding or second image embedding into data categories comprised in the multi-dimensional vector space; and
generating a report, based at least on the semantic search computing operation or the classification or clustering computing operation.

2. The method of claim 1, wherein the embeddings computing model is parameterized by:
the text encoder, the text encoder being configured to convert text data derived from one or more disparate file formats that contain the first raw geoscience or energy domain data into a first transformed data,
the image encoder, the image encoder being configured to convert image data derived from one or more disparate file formats that contain the first raw geoscience or energy domain data into a second transformed data, and
a projection parameter or transformer configured to transform or map the first transformed data and the second transformed data into the multi-dimensional vector space.

3. The method of claim 2, further comprising applying a loss function to the configured computing model to improve a response or predictive accuracy of the configured computing model.

4. The method of claim 3, wherein the loss function is based on a cosine similarity computing operation, the cosine similarity computing operation comprising a computing operation that measures a similarity or dissimilarity between:
a first vector in the multi-dimensional vector space representing the first text embedding or the first image embedding, and
a benchmark vector associated with the multi-dimensional vector space and which represents ground truth data associated with the first resource site, such that the similarity or dissimilarity is based on a cosine of an angle between the first vector and the benchmark vector.

5. The method of claim 1, wherein the first raw geoscience or energy domain data comprises:
seismic data captured at the first resource site or the second resource site,
well log data associated with the first resource site or the second resource site,
geochemical data associated with the first resource site or the second resource site, and
remote sensing data associated with the first resource site or the second resource site.

6. The method of claim 1, wherein the similarity data is generated based on a contrastive computing process that determines whether the first text embedding has a link or a connection to the first image embedding.

7. The method of claim 6, wherein the link or connection indicates that the first text embedding is associated with a subsurface structure characterized by the first image embedding.

8. The method of claim 1, wherein the multi-dimensional vector space comprises:
the first plurality of textual data and image data as a first set of datapoints in a vector space, and
the second plurality of textual data and image data as a second set of datapoints in the vector space.

9. The method of claim 8, wherein the vector space is configured for organizing and processing raw or unstructured geoscience data or energy domain data.

10. The method of claim 8, wherein:
the first set of datapoints comprise a first numerical vector, and
the second set of datapoints comprise a second numerical vector.

11. The method of claim 1, wherein configuring the embeddings computing model comprises one of:
applying, a contrastive learning computing operation to train the embeddings computing model to determine whether the first text embedding and the first image embedding comprise a positive pair, the positive pair indicating a data relationship or a data linkage between the first text embedding and the first image embedding, and
applying, the contrastive learning computing operation to train the embeddings computing model to determine whether the first text embedding and the first image embedding comprise a negative pair, the negative pair indicating an absence of the data relationship or a data linkage between the first text embedding and the first image embedding.

12. The method of claim 11, wherein the data relationship or data linkage between the first text embedding and the first image embedding indicate a text description and its matching image associated with sensor measurements capturing surface or subsurface data associated with the first resource site or the second resource site.

13. The method of claim 1, wherein the user input comprises a digital question or a computing request to determine energy development information associated with the second raw geoscience or energy domain data based on the configured embeddings computing model.

14. The method of claim 1, wherein the report comprises one or more of:
subsurface data indicating subsurface data relationships between rocks, minerals, and geological processes associated with the first resource site or the second resource site based on the user input,
responses or retrieved documents associated with the subsurface data relationships based on the user input,
multimodal data integration that combines effects of the subsurface data indicating the relationships between the rocks, minerals, and geological processes associated with the first resource site or the second resource site,
predictive modeling data indicating one or more of:
a first recommendation strategy for energy exploration associated with the first resource site or the second resource site,
a second recommendation strategy for extracting energy from the first resource site or the second resource site,
an energy production forecast associated with the first resource site or the second resource site, and
an energy transportation strategy associated with the first resource site or the second resource site.

15. The method of claim 14, wherein the report comprises a visualization comprising textual or image data indicating the subsurface data, the responses or retrieved documents, and the predictive modeling data.

16. The method of claim 1, wherein the first raw geoscience or energy domain data comprising the first plurality of textual data and image data having the first plurality of disparate file formats or document formats is converted into a unified file or document format comprising a markdown data format prior to the pairing.

17. A system for converting raw geoscience data or energy domain data into a multi-dimensional vector space for predictive modeling in energy development, the system comprising:
a computer processor, and
memory storing instructions that are executable by the computer processor to:
determine an embeddings computing model associated with geoscience data or energy domain data;
receive first raw geoscience or energy domain data associated with a first resource site, such that the first raw geoscience or energy domain data comprises a first plurality of textual data and image data having a first plurality of disparate file formats or document formats;
pair data samples comprised in the first plurality of textual data and image data having the first plurality of file formats, thereby generating one or more of first paired data samples;
activate one or more of:
a text encoder comprised in the embeddings computing model, the text encoder comprising a transformer-based computing architecture,
an image encoder comprised in the embeddings computing model, the image encoder comprising one of a computer vision transformer or a convolutional neural network;
train, based on the one or more of the paired data samples, the embeddings computing model to determine similarity data between:
a first text embedding that is generated based on applying a first paired text-image sample comprised in the one or more of the paired data samples to the text encoder, and
a first image embedding that is generated based on applying the first paired text-image sample comprised in the one or more of the paired data samples to the image encoder;
implement, one of:
aggregating together, based on the similarity data, the first text embedding and the first image embedding in a multi-dimensional vector space, and
separating from each other, based on the similarity data, the first text embedding from the first image embedding in the multi-dimensional vector space;
configure, based on the aggregating or separating, the embeddings computing model thereby generating a configured embeddings model;
receive second raw geoscience or energy domain data associated with the first resource site or a second resource site, such that the second raw geoscience or energy domain data comprises a second plurality of textual data and image data having a second plurality of disparate file formats or document formats;
receive a user input associated with the second raw geoscience or energy domain data;
apply the second raw geoscience and energy domain data and the user input to the configured embeddings model thereby generating one or more of:
a second text embedding associated with the second raw geoscience or energy domain data, and
a second image embedding associated with the second raw geoscience or energy domain data;
implement, based on the applying, one or more of:
a semantic search computing operation to determine a matching between the first text embedding or the first image embedding and the second text embedding or the second image embedding respectively,
a classification or clustering computing operation that classifies the second text embedding or second image embedding into data categories comprised in the multi-dimensional vector space; and
generate a report, based at least on the semantic search computing operation or the classification or clustering computing operation.

18. The system of claim 17, wherein the first raw geoscience or energy domain data comprises:
seismic data captured at the first resource site or the second resource site,
well log data associated with the first resource site or the second resource site,
geochemical data associated with the first resource site or the second resource site, and
remote sensing data associated with the first resource site or the second resource site.

19. The system of claim 17, wherein the similarity data is generated based on a contrastive computing process that determines whether the first text embedding has a link or a connection to the first image embedding.

20. The system of claim 17, wherein the multi-dimensional vector space comprises that represents:
the first plurality of textual data and image data as a first set of datapoints in a vector space, and
the second plurality of textual data and image data as a second set of datapoints in the vector space.
